(19) United States
(12) Patent Application Publication
(10) Pub. No.: US 2008/0055744 A1
(43) Pub. Date: Mar. 6, 2008

(54) Connecting structure for a lens and a main board

(76) Inventors: Feng Chang, Hsinchu (TW); Chih-Shen Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/513,078

(22) Filed: Aug. 31, 2006

(51) Int. Cl. G02B 7/02

(52) U.S. Cl. 359/811

(57) ABSTRACT

A connecting structure for a lens and a main board includes a board having a first through hole, a lens module having a second through hole, and at least one connecting device. The connecting device passes through the first through hole and the second through hole to connect the board and the lens module. The connecting device has a first adjusting part that corresponds to the first through hole, and a second adjusting part that corresponds to the second through hole. The first through hole and the second through hole are adjusted and controlled via the first adjusting part and the second adjusting part so that there is a proper space between the lens module and the board. The flatness of the lens module affected by the warp of the main board is avoided and the MTF of the lens module is kept on its best state.

### BACKGROUND OF THE INVENTION

1. Field of the Invention

The present invention relates to a connecting structure for a lens module and a main board. In particular, this invention relates to a connecting structure for a lens module and a main board that can be manually fine-tuned the flatness of the lens module and prevent the board from becoming warped.

2. Description of the Related Art

The image quality of a photo is determined in the photo taking process. When the MTF (Modulation Transfer Function) of a camera machine is high, including the camera machine's definition and sharpness, an excellent digital image is available.

For both digital camera machines and conventional camera machines, MTF is determined by the lens module, rather than by light-sensing material. Therefore, the lens module dominates the optical characteristics, including definition and sharpness etc. A lens module having an excellent MTF can differentiate scenery more clearly. The obtained image is more detailed. Recently, the technology for enhancing the MTF of the lens module has been further developed.

In fact, the MTF of a lens module is determined by both the lens sets located in the lens module and the assembled flatness of the lens module. When the lens module is assembled on a tilt, the flatness is bad and the MTF of the lens module cannot perform in its optimum state.

A general method for fastening the lens of the digital camera machine is implemented by connecting the lens module and the printed circuit board (PCB) via a full thread screw.

However, the described digital camera machine structure has some drawbacks. When the PCB is manufactured, the PCB is heated via a soldering oven. The warp of the PCB may be up to 10% during the heating process. So if the thickness of the PCB is 1.0 mm, the warping dimension can be 0.1 mm. When the lens module is combined with the PCB, the MTF of the conventional camera machine is determined. When the warp of the PCB is bad, the lens module tilts and the flatness of the lens module is inadequate. The MFT of the lens module lowers. Some methods have been proposed to solve the problem.

1. The specification of the MTF is lowered. However, when the MTF is lowered, the competitiveness of the camera machine decreases.

2. Utilizing the connecting force generated from the front and rear external shells of the camera machine to reduce the warp of the PCB and adjust the MTF. However, the connecting force generated from the front and rear external shells cannot be controlled and it is unreliable for improving the MTF.

### SUMMARY OF THE INVENTION

One particular aspect of the present invention is to provide a connecting structure for a lens and a main board. The lens module can be manually fine-tuned to have its best possible MTF. After the lens module is combined, the warp of the min board is decreased. Therefore, the flatness of the lens module disturbed by the warp of the main board is avoided.

The connecting structure for a lens and a main board includes a board having at least one first through hole, a lens module having at least one second through hole, and at least one connecting device. The connecting device passes through the first through hole and the second through hole to connect the board and the lens module. The connecting device has a first adjusting part that corresponds to the first through hole, and a second adjusting part that corresponds to the second through hole.

The first through hole and the second through hole are adjusted and controlled via the first adjusting part and the second adjusting part so that there is a proper space between the lens module and the board. The flatness of the lens module affected by the warp of the main board is avoided and the MTF of the lens module is kept in its best state.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of the present invention;

FIG. 2 is an exploded perspective view of the present invention;

FIG. 3 is another perspective view of the present invention;

FIG. 4 is a perspective view of the connecting device of the present invention;

FIG. 5 is a side view of the present invention;

FIG. 6 is a side view of the second embodiment of the present invention;

FIG. 7 is a perspective view of the connecting device of the third embodiment of the present invention; and

FIG. 8 is a side view of the third embodiment of the present invention.

### DETAILED DESCRIPTION OF THE PREFERRED EMBODIMENTS

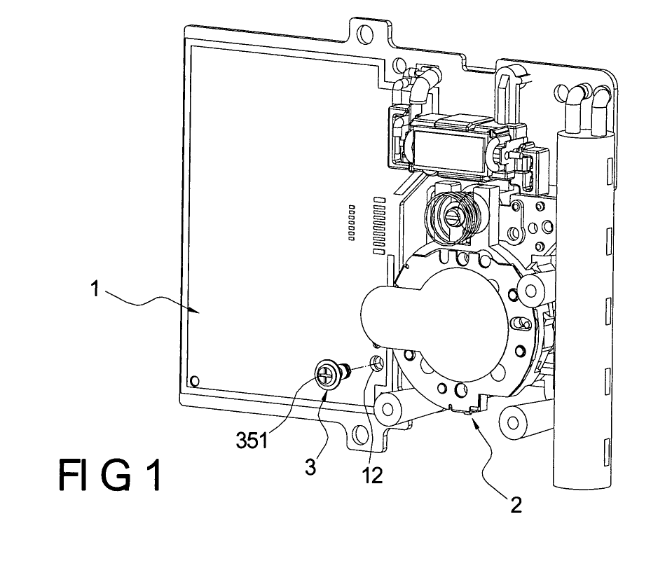

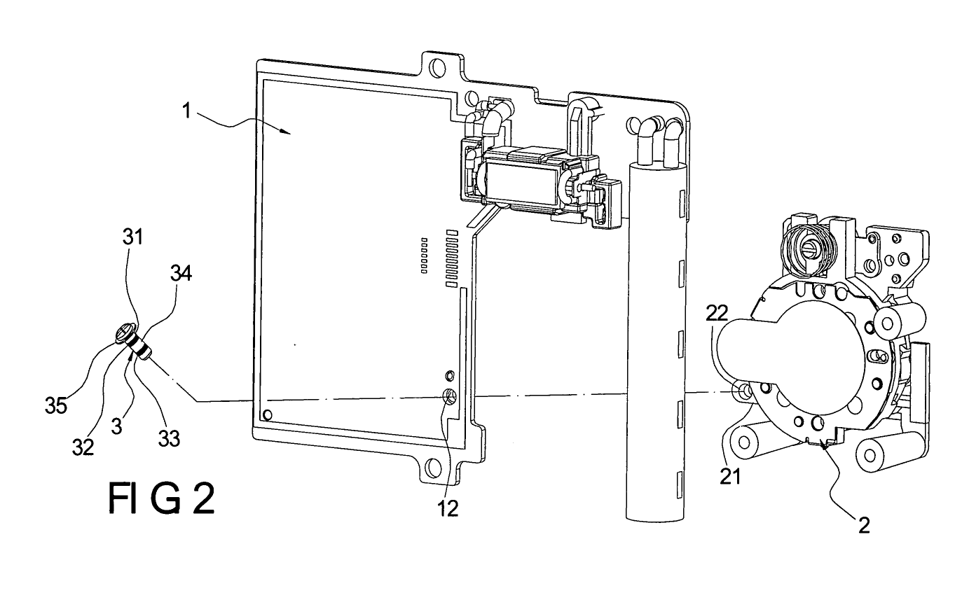

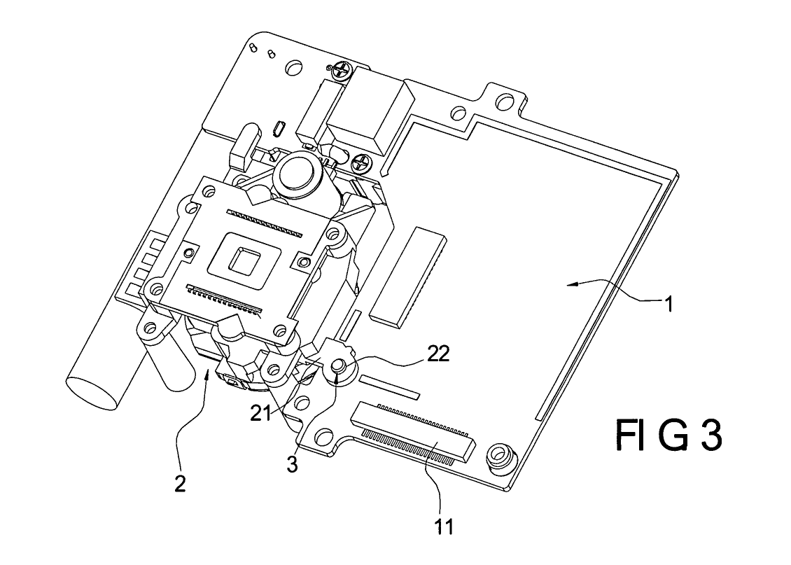

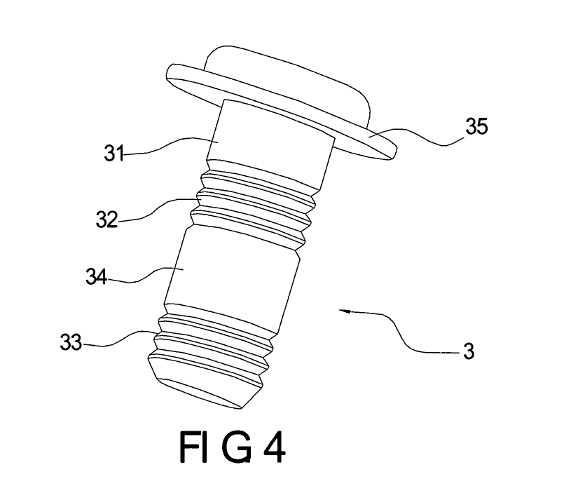

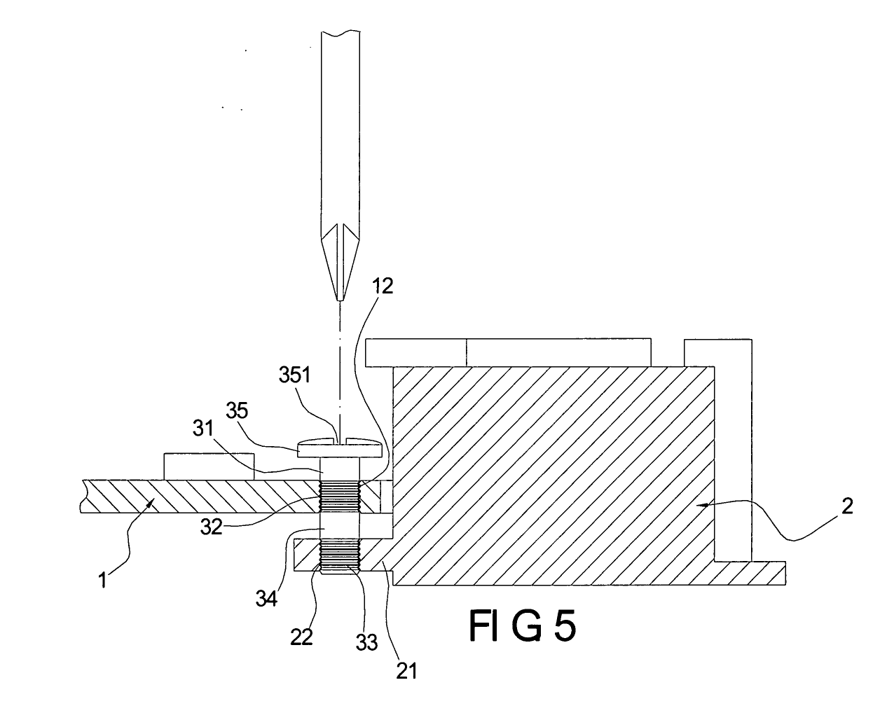

Reference is made to FIG. 1. The connecting structure for a lens and a main board of the present invention includes a board 1, a lens module 2, and a connecting device 3. As shown in FIGS. 1, 2, 3, 4 and 5, the board 1 is a printed circuit board (PCB). On the surface of the board 1, there are a plurality of integrated circuits 11. On a proper location of the board 1, there is a first through hole 12, and there is a thread in the first through hole 12.

An assembling arm 21 extends from one side of the lens module 2. There is a second through hole 22 on the assembling arm 21, and there is a thread in the second through hole 22.

The connecting device 3 is composed of a metallic material or a rubber material for connecting the board 1 with the lens module 2. The connecting device has a rod 31 that passes through the first through hole 12 and the second through hole 22. A first adjusting part 32 and a second adjusting part 33 are disposed on the rod 31 at a distance. A separating part 34 is formed on the rod 31 and located between the first adjusting part 32 and the second adjusting part 33. The first adjusting part 32 has a thread located at one part of the surface of the rod 31 that corresponds to the thread of the first through hole 12. The second adjusting part 33 has a thread located at another part of the surface of the rod 31 that corresponds to the thread of the second through hole 22. At one end of the rod 31, there is a nut 35 and the nut 35 has a rotating-adjusting hole 351.

A screwdriver or a related tool is used to adjust and control the first adjusting part 32 and the second adjusting part 33 of the connecting device 3 via the rotating-adjusting hole 351 so that the first adjusting part 32 and the second adjusting part 33 respectively correspond to the first through hole 12 of the board 1 and the second through hole 22 of the lens module 2. Therefore, the lens module 2 is combined with the board 1 firmly. The first through hole 12 and the second through hole 22 are fine-tuned and controlled via the first adjusting part 32 and the second adjusting part 33 so that there is a proper space between the lens module 2 and the board 1. Therefore, the warp of the board generated in the heating process is located at the separating part 34 between the first adjusting part 32 and the second adjusting part 33. The warp of the board 1 will not disturb the lens module 2 so that the flatness of the lens module 2 is kept up and the MTF of the lens module 2 is kept on its best state.

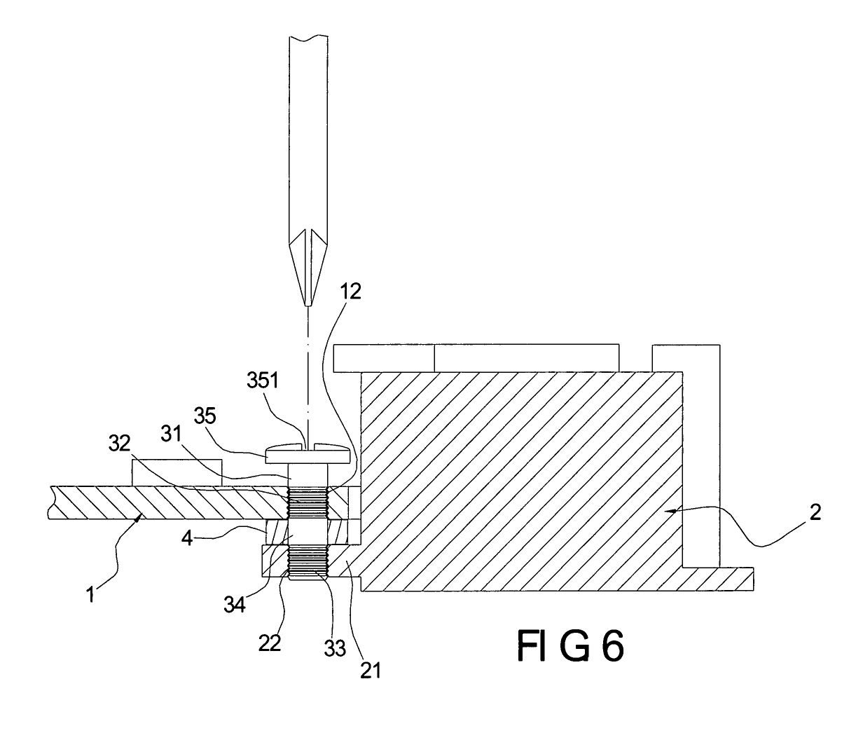

FIG. 6 shows the second embodiment of the present invention. The proper space between the board 1 and the lens module 2 have a cushioning unit 4 that is made of Styrofoam. The cushioning unit 4 is sleeved on the separating part 34 of the connecting device 3.

Because there is a cushioning unit 4 between the lens module 2 and the board 1, the lens module 2 is positioned well and the MTF of the lens module 2 is kept on its best state.

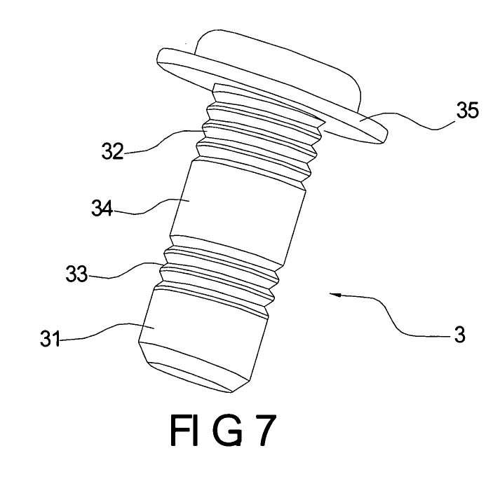

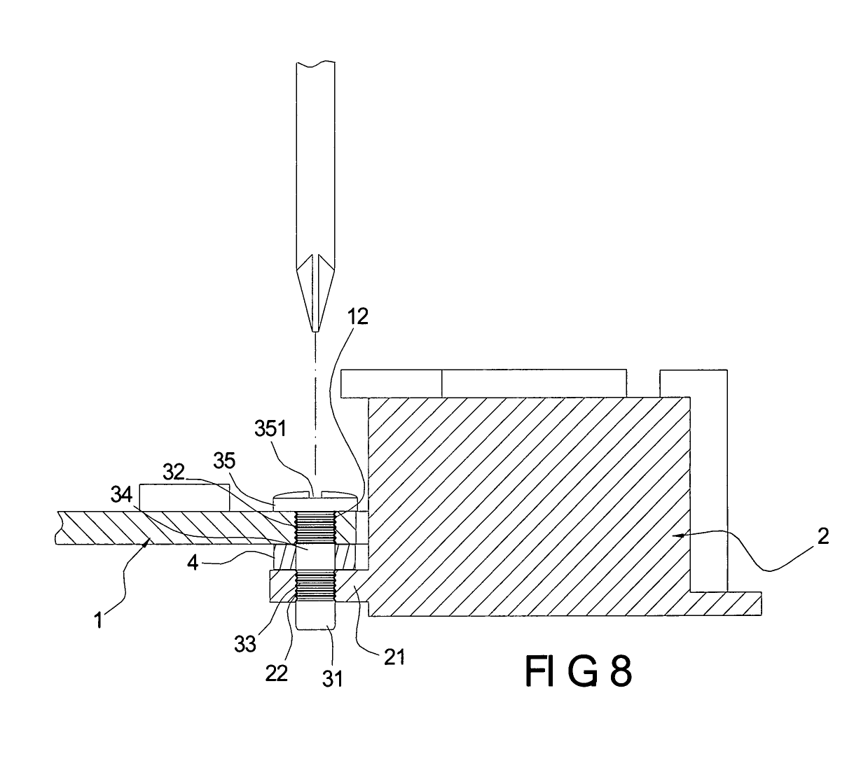

FIGS. 7 and 8 show the third embodiment of the present invention. The first adjusting part 32 of the connecting device 3 is adjacent to the nut 35.

The first adjusting part 32 and the second adjusting part 33 of the connecting device 3 respectively correspond to the first through hole 12 of the board 1 and the second through hole 22 of the lens module 2. When the lens module 2 is combined and positioned with the board 1, the bottom of the nut 35 leans exactly on the board 1 and there is a cushioning unit 4 between the lens module 2 and the board 1. The lens module 2 is positioned well.

The present invention has the following characteristics:

1. The present invention utilizes the connecting device 3 to adjust and control the board 1 and the lens module 2 so that there is a proper space between them both. Therefore, the warp of the board 1 generated in the heating process is located at the separating part 34. The warp of the board 1 will not disturb the lens module 2 so that the lens module disturbed by the warp of the main board is avoided and the flatness of the lens module 2 is kept up.

2. The present invention fine-tunes the connecting device 3 to improve the flatness of the lens module 2, and the MTF of the lens module 2 is kept on its best state.

3. The present invention has a cushioning unit 4 between the lens module 2 and the board 1 so that the lens module 2 is positioned well.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A connecting structure for a lens and a main board, comprising:
a board having at least one first through hole;
a lens module having at least one second through hole; and
at least one connecting device, wherein the connecting device passes through the first through hole and the second through hole to connect the board and the lens module, and the connecting device has a first adjusting part that corresponds to the first through hole, and a second adjusting part that corresponds to the second through hole;
wherein the first through hole and the second through hole are adjusted and controlled via the first adjusting part and the second adjusting part so that there is a proper space between the lens module and the board.

2. The connecting structure for a lens and a main board as claimed in claim 1, wherein the board is a printed circuit board.

3. The connecting structure for a lens and a main board as claimed in claim 1, wherein at least one assembling arm extends from one side of the lens module, and the second through hole is located at the assembling arm.

4. The connecting structure for a lens and a main board as claimed in claim 1, wherein the connecting device has a rod, and the first adjusting part and the second adjusting part are disposed on the rod at a distance.

5. The connecting structure for a lens and a main board as claimed in claim 4, wherein one end of the rod has a nut.

6. The connecting structure for a lens and a main board as claimed in claim 5, wherein the nut has a rotating-adjusting hole.

7. The connecting structure for a lens and a main board as claimed in claim 5, wherein the first adjusting part is adjacent to the nut.

8. The connecting structure for a lens and a main board as claimed in claim 1, wherein the first adjusting part has a thread located at one part of the surface of the rod, and the first through hole has a corresponding thread.

9. The connecting structure for a lens and a main board as claimed in claim 1, wherein the second adjusting part has a thread located at another part of the surface of the rod, and the second through hole has a corresponding thread.

10. The connecting structure for a lens and a main board as claimed in claim 1, wherein the connecting device between the first adjusting part and the second adjusting part forms a separating part.

11. The connecting structure for a lens and a main board as claimed in claim 1, wherein the connecting device is made of metallic materials.

12. The connecting structure for a lens and a main board as claimed in claim 1, wherein the connecting device is made of rubber materials.

13. The connecting structure for a lens and a main board as claimed in claim 1, wherein there are a plurality of integrated circuits disposed on surface of the board.

14. A connecting structure for a lens and a main board, comprising:
a board having at least one first through hole;
a lens module having at least one second through hole;
at least one connecting device, wherein the connecting device passes through the first through hole and the second through hole to connect the board and the lens module, and the connecting device has a first adjusting part that corresponds to the first through hole, and a second adjusting part that corresponds to the second through hole; and
a cushioning unit located between the board and the lens module.

15. The connecting structure for a lens and a main board as claimed in claim 14, wherein the cushioning unit is made of Styrofoam.

16. The connecting structure for a lens and a main board as claimed in claim 14, wherein the cushioning unit is sleeved on the connecting device.
